(19) United States
(12) Patent Application Publication
(10) Pub. No.: US 2012/0136800 A1
(43) Pub. Date: May 31, 2012

(54) System and Method for Rapid MLS Listing Management

(76) Inventor: Ben Caballero, Plano, TX (US)

(21) Appl. No.: 12/956,278

(22) Filed: Nov. 30, 2010

(51) Int. Cl. G06Q 50/00

(52) U.S. Cl. 705/313

(57) ABSTRACT

A system for the creation and management of MLS listing. Profiles are created for each subdivision the builder client builds in and for each house plan the builder builds. The Profiles store all information needed for an MLS listing that does not change for each home. With the profile when a user wishes to order a listing for a home that is being started they can choose the subdivision from a drop down menu and then select the floor plan from another drop down menu and press a button which then creates a pre-populated form. The user then needs only to enter the address, legal description, lot size, price and any special features unique to the particular home or lot and they are finished. In the system, a user can create a listing request in one or two minutes as opposed to filling out an eight page data input form.

### TECHNICAL FIELD OF THE INVENTION

The present invention relates generally to a computer program and method for managing a Real Estate Multiple Listing Service (MLS) system. More specifically the present invention relates to a software system that allows a user to manage listing data in an MLS system.

### BACKGROUND OF THE INVENTION

Each day, thousands of properties in the United States are offered for sale. The real estate industry uses, as its primary search and indexing tool, various multiple listing services (MLSs) storing information on properties for sale or rent. The MLSs allow real estate brokers to list properties as well as search for properties using simple Boolean searches. For instance, real estate brokers may search for properties of certain type, cost, location and/or features.

The MLSs were formed to facilitate cooperation between real estate brokers. Two of the most important results of the formation of MLSs are (a) the compilation and dissemination of member real estate brokers' property listings into a common database for member broker usage and (b) to provide sellers with much broader market exposure. MLSs exist to offer centralized services to their broker members, to expedite the sale of a homeowner's property by generating competition among real estate agents, and to protect the integrity and use of the MLS data. An MLS's primary focus is to promote the interests of sellers, but only to the extent that such promotion is not in conflict with what is in the best interest of its broker members and their clients as a monitor and enforcer of privacy and data protection standards.

The databases compiled by the MLSs for their broker members are comprised of several types and ages of data, including: active listings of properties for sale or lease, off-market listings (including pending sale, expired and canceled listings, and withdrawn listings), sold or leased listings, and property details such as photos of the listed properties, and includes both commercial and residential properties.

While many disparate sources exist to compile some similar data, the MLS databases are an extensive and comprehensive source of detailed property and community characteristics among other information, and include approximately 82% of all properties sold annually in the U.S. The source of many of these data elements is limited to the MLS, which has a competitive advantage in the market place because it has the best currency and completeness.

Currently with new homes, there is no ability for an agent, broker, or other user to create and store profiles that would make the use of the MLSs more efficient and easier. What is needed is the ability to create profiles for each subdivision a builder client builds in and for each house plan the builder builds. These profiles store all information needed for an MLS listing that does not change for each home. Thus, an agent, broker, or user would not be required to continually re-enter the same information for multiple properties that are built or are to be built.

### SUMMARY OF THE INVENTION

In accordance with the present an organization system is provided which overcomes the aforementioned problems of the prior art. The present invention is system for the creation and management of MLS listings. Profiles are created for each subdivision the builder client builds in and for each house plan the builder builds. The Profiles store all information needed for an MLS listing that does not change for each home.

With the profile when a user wishes to order a listing for a home that is being started they can choose the subdivision from a drop down menu and then select the floor plan from another drop down menu and press a button which then creates a pre-populated form. The user then needs only to enter the address, legal description, lot size, price and any special features unique to the particular home or lot and they are finished. In the system of the present invention, a user can create a listing request in one or two minutes as opposed to filling out a multi-page data input form.

Subdivision Profiles include: city, subdivision name, directions to subdivision, office phone number, Zip code, school district, school names, map coordinated, contact details, phones, email, office hours, et cetera never change. Plan Profiles include stories, bedrooms, baths, type construction, roof type, features, parking type et cetera remain constant.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flow chart illustrating the MLS management method of the present invention;

FIG. 2 is a flow chart illustrating the application of the MLS management method of the present invention as performed by a program storage medium readable by a machine, tangibly embodying a program of instructions executable by a machine to perform the method steps;

FIG. 3 is an illustrative system interface screen image of the present invention as displayed on a computer;

FIG. 4 is an illustrative form interface screen image of the present invention as displayed on a computer;

FIGS. 5-6 are illustrative profile screen images of the present invention as displayed on a computer;

FIG. 7 is an illustrative form interface screen image of the present invention as displayed on a computer;

FIGS. 8-9 is an illustrative MLS information entry screen images of the present invention as displayed on a computer;

FIG. 10 is an illustrative photograph entry screen image of the present invention as displayed on a computer;

FIG. 11 is an illustrative importing of resources and pictures screen image of the present invention as displayed on a computer;

FIG. 12 is an illustrative image importing screen image of the present invention as displayed on a computer;

FIG. 13 is an illustrative picture description screen image of the present invention as displayed on a computer;

FIG. 14 is an illustrative virtual tour screen image of the present invention as displayed on a computer;

FIG. 15 is an illustrative photo request screen image of the present invention as displayed on a computer;

FIG. 16 is an illustrative photo request form screen image of the present invention as displayed on a computer;

FIGS. 17-18 are illustrative MLS listing update request screen images of the present invention as displayed on a computer;

FIG. 19 is an illustrative notification box screen image of the present invention as displayed on a computer;

FIG. 20 is an illustrative status update screen image of the present invention as displayed on a computer;

FIGS. 21-23 are illustrative status update screen images of the present invention as displayed on a computer; and

FIGS. 24-27 are illustrative overview screen images of the present invention as displayed on a computer.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

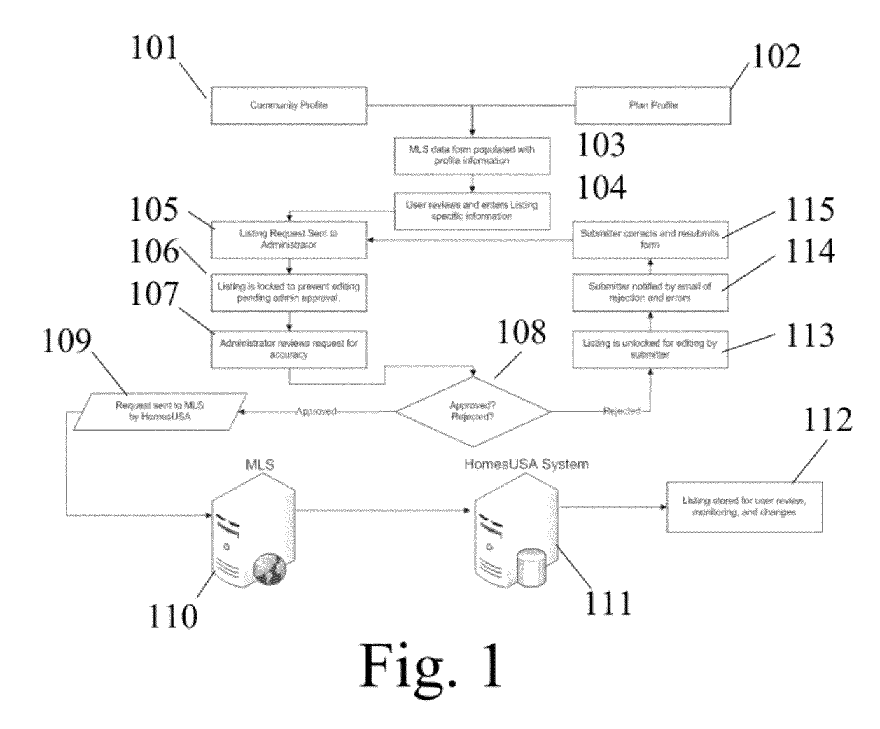

Now referring to FIG. 1, a flow chart illustrates the MLS management method taught by the present invention. The first two steps are the creating of community/subdivision profiles 101 and plan profiles 102. Community/Subdivision Profiles 101 include: city, subdivision name, directions to subdivision, office phone number, Zip code, school district, school names, map coordinated et cetera never change. Plan Profiles 102 include stories, bedrooms, baths, type construction, roof type, type parking et cetera remain constant.

The community/subdivision profiles 101 and plan profiles 102 are then used to populate an MLS data form with profile information in step 103. Next, a user reviews and enters listing specific information in step 104 that is not found in the community/subdivision profiles 101 and plan profiles 102 but is desired to be part of the MLS profile information. Next, the listing is sent to an administrator 105. The listing is locked to prevent editing pending administrator approval 106 and the administrator review the request for accuracy 107 and then either approves or rejects the request 108. If the request is approved, the request is sent to the MLS by the system 109, where it is received and stored by the MLS server 110, received and stored by the systems server and database 111 for review, monitoring, and editing by a user 112. If the request is rejected, the listing is unlocked for editing by the submitting user 113. The submitting user is notified by email of the rejection and errors in the submission 114, and the submitting user has the opportunity to correct and resubmit the form 115. Upon resubmission, steps 105-108 be repeated until either the request is approved or the user fails to resubmit a correction of a previously submitted rejected request.

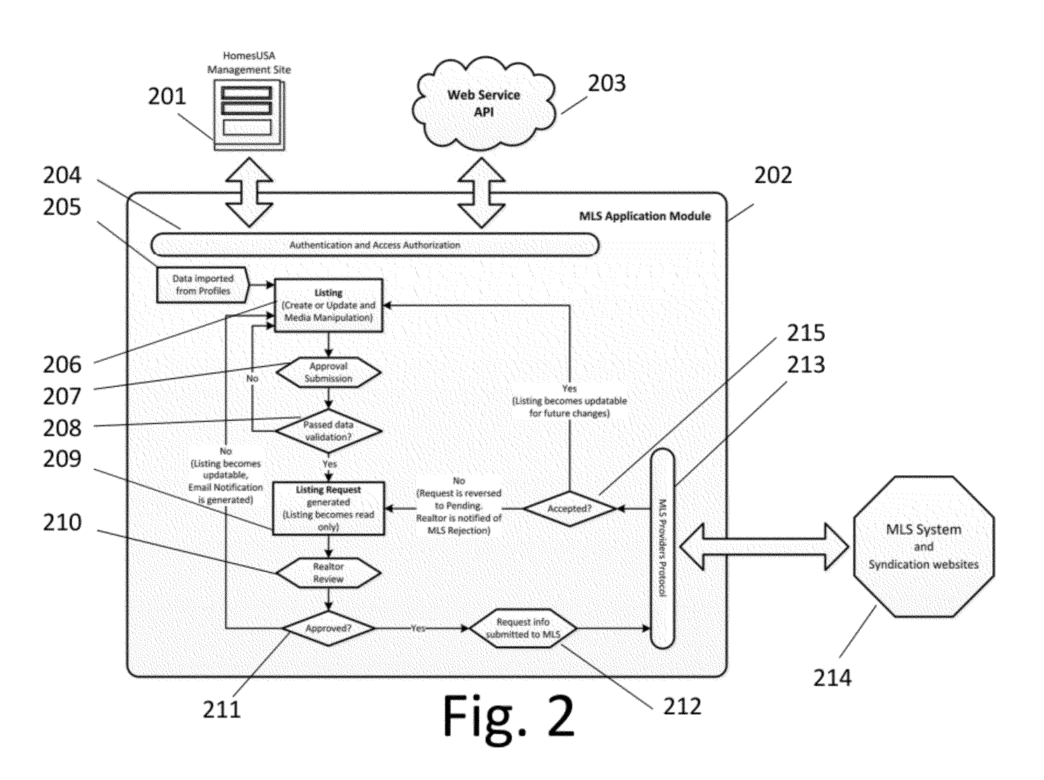

FIG. 2 is a flow chart illustrating the application of the MLS management method of the present invention as performed by a program storage medium readable by a machine, tangibly embodying a program of instructions executable by one or more machines to perform the method steps. The program is stored on a system server website 201 as an MLS application module or web service 202 that uses a web service API 203 to enable user access to the MLS application module 202 stored on the system server 201. In FIG. 2, the system server website 201 and MLS application module or web service 202 communicates with the web service API 203 independently.

In other words, The Application Module can be accessed through the Website User Interface or Web service.

The MLS application module 202 provides authentication and access authorization 204 by the system server website 201 and web service API 203. Once granted access to the MLS application module 202, data from community/subdivision profiles 101 and plan profiles 102 is imported in step 205 to the listing 206. After creation, updating or other manipulation, the listing 206 is submitted for approval in step 207. If the listing 206 passes the data validation 208, a listing request is generated 209 and the listing 206 becomes read only. If the listing 206 does not pass data validation 208, the listing can be edited or updated in step 206 and re-submitted for approval 207.

Upon the listing 206 passing the data validation 208, and generating a listing request 209, the generated listing request 209 is then subject to a realtor review 210. If the listing 206 is approved in step 211 by the realtor review, the generated listing request 209 is submitted to the MLS 212. If the generated listing request 209 is not approved in step 211 by the realtor review, the listing 206 becomes updateable, an email notification is generated, and the process repeats with the creating or updating of the listing 206.

After the generated listing request 209 is approved in step 211 by the realtor review and the listing 206 is submitted to the MLS 212, the listing 206 undergoes review in step 213 to ensure it complies with the MLS providers' protocol. An external MLS system and/or syndication of websites 214 provides the MLS application module 202 with the protocol for step 213. If the generated listing request 209 is accepted in step 215, the listing 206 becomes updateable for future changes and entered into the MLS system and/or syndication of websites 214. If the generated listing request 209 is not accepted in step 215, the generated listing request 209 request is reversed to a pending status and the user/realtor is notified of the MLS rejection so the user/realtor may review the generated listing request 209 in step 210 and either re-submit it for approval or update the listing 206 for re-submission.

The method of the listing management system creates a timesavings for the user. Listings are pre-populated by the community/subdivision profiles and plan profiles, which reduces data entry by approximately 90% and ensure accuracy of the listings. The syndication of the listings to one or more MLS systems and/or syndication websites also provides a timesavings as the listing output of the system is automatically distributed and can be managed from a single source for multiple distribution channels.

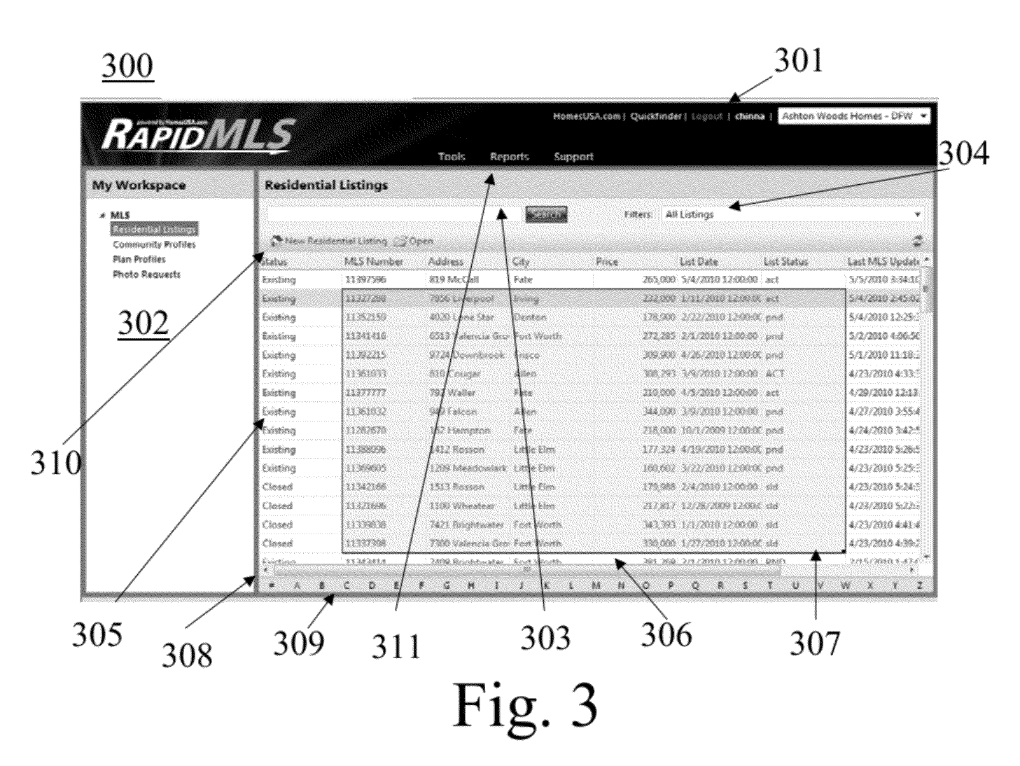

To use the system and method for rapid MLS listing management of the present invention as taught as being a system recorded on computer-readable medium and capable of execution by a computer, a user/realtor would first create an account and login in using an established username and password. Upon login, the user/realtor would be presented with a system interface 300 as illustrated in FIG. 3. The various components of the system interface 300 include: Context Links, My Workspace, Search Bar, Filters, Grid, Select, Scroll Bar, Alpha Jump Bar, Toolbar, and Menu.

Context Links 301 provide selection for a user/realtor who is responsible for one or more company brands. My Workspace 302 provides an area where objects can be selected to work with. The Search Bar 303 is used to search for objects within the system. Filters 304 reduce the number of records displayed the in the grid 305. The Grid 306 is comprised of manage data an may be reorganized by sorting or resizing any columns. A user/realtor may select areas 307 of the grid to copy and paste into another program such as EXCEL or WORD. When visible, a scroll bar 308 allows a user/realtor to scroll horizontally within an object. An Alpha Jump Bar 309 is used to show only information beginning with the selected character for a system specified field. Tools from a toolbar 310 can be selected to create new objects, open objects or refresh data that is shown in the grid below. Finally, the Menu 311 gives access to special content, like reports or configurations.

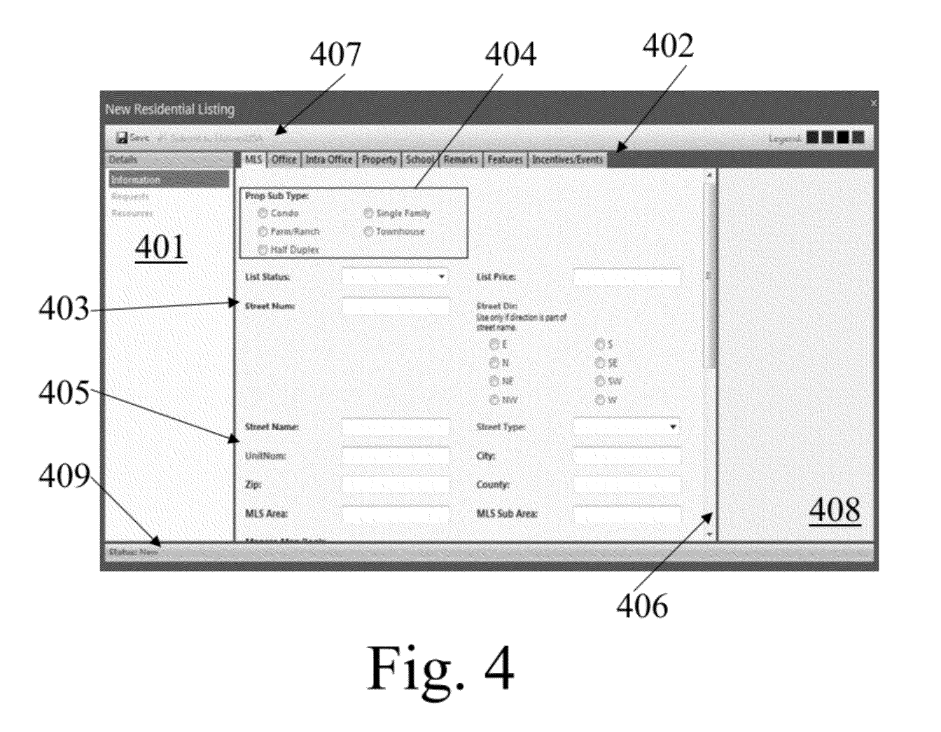

The system of the present invention works based on objects, known for some people as entities or business objects. The form shown in FIG. 4 represents an object, it also contains information related to that object. The Details Pane 401 illustrates different links that can be selected to work with in this screen. These links show extra information related to the object represented in the form. Tabs 402 represents an object segment, they can be completed in any order and may be returned to by selecting it at any time. Required Labeled Fields 403 are required to be completed before saving an object. Action Labeled Fields 404 required an action to be completed before submitting an object. Optional Labeled Fields—405 are not required to be completed before saving an object. A Scroll Bar 406 is visible and allows a user to scroll vertically within an object. The Toolbar 407 contains many actions that can be taken for a particular object. The Notification Pane 408 notifies a user about errors, field descriptions, and any other notifications in an object. The Status Bar 409 displays the status of the object after an action has been made.

Numeric Fields require numerical values such as integers and decimals, if a text or any symbol is entered in this field, it will automatically be removed. Radio Button/Drop Down List Fields require that only one (1) selection can be made in these fields. Date Fields require numerical values such as dates. Text Fields require text values such as letters and symbols. Text fields that require number values will be aligned to the left of the field. Text Area Fields allow for any value to be entered in these fields such as text, numbers, and symbols. Text area fields also indicate character count limits within the field. Check Box Fields are where multiple selections can be made, but some fields restrict certain amount of selections.

Many fields have validations. Depending on the value entered in those fields, some other fields may be required. As an example, the value has been changed in the “NumLiving Areas” field. Additional fields are required to apply to the value entered in that field. Many fields are also grouped together. Depending on the value entered in one field, the other fields within that group will be required. A value entered in the first field of the group, the other fields light up to show they are required.

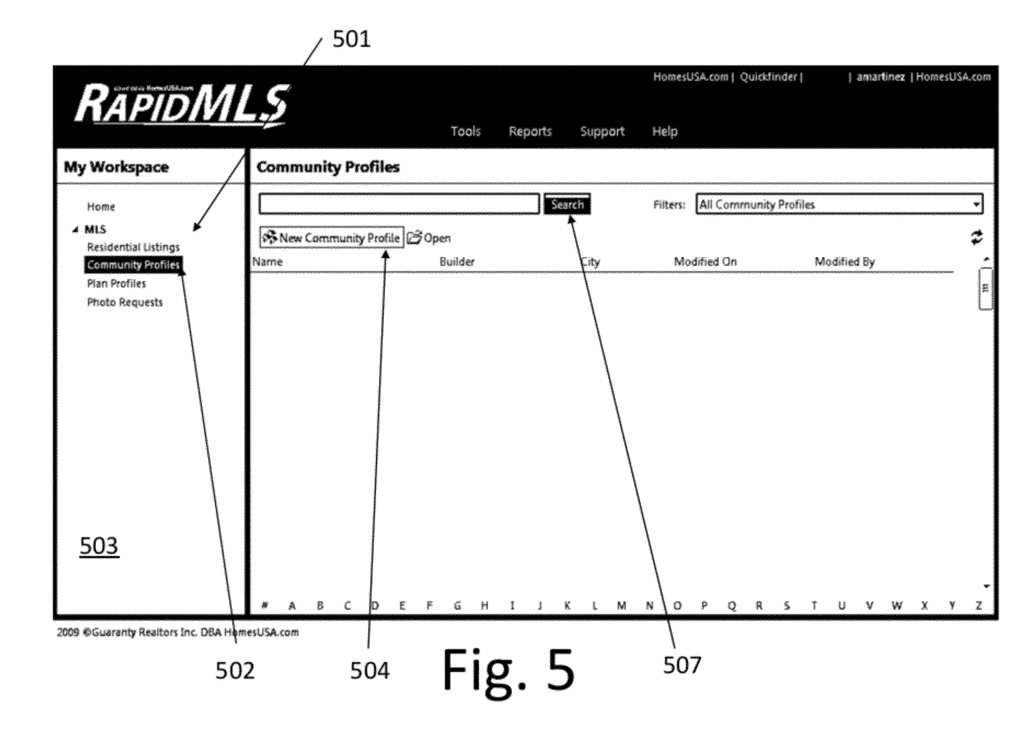

As shown in FIG. 5, the process for creating profiles is now discussed, the system defaults to “Residential Listings” 501 once logged in. Next, “Community Profiles” 502 under “My Workspace” 503 are selected. If setting up plan profiles then a user would select “Plan Profiles” and follow the steps from there. Next a user selects “New Community Profile” 504.

Selecting the house 505 in the toolbar 506 imports information from a listing. Selecting and entering specific criteria to a search is completed by. Selecting “Search” 507. Once the name of the community being created is shown, a user selects the listing to import the information. Once processed, a user enters the name of the community being created.

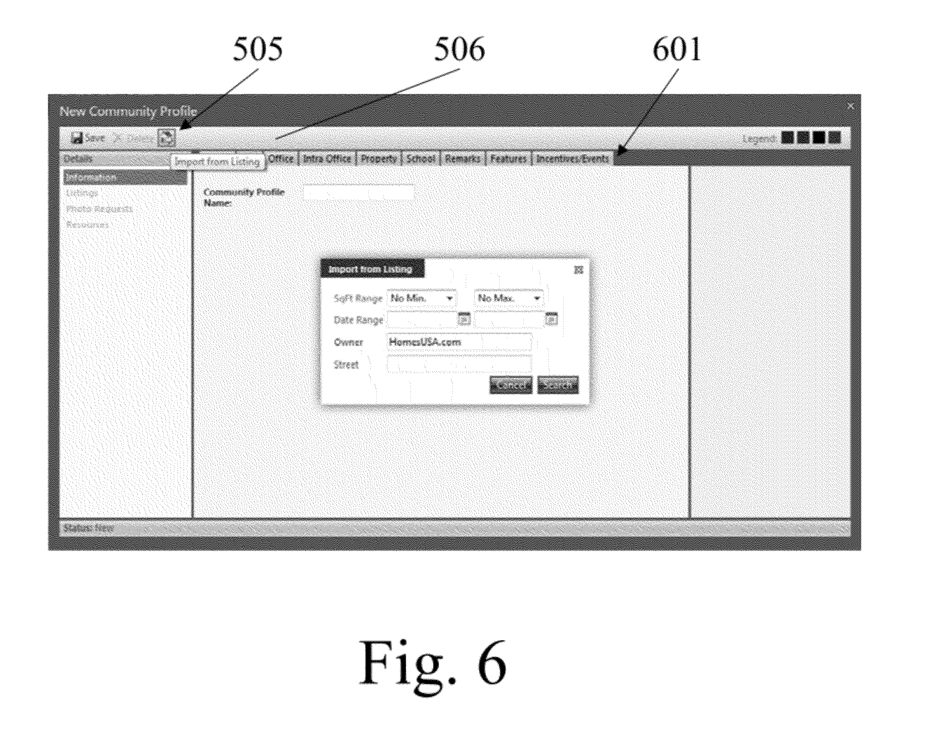

As shown in FIG. 6, selections on each segment tab 601 confirm information and accuracy is correct for the community, and allow a user to make necessary changes if needed.

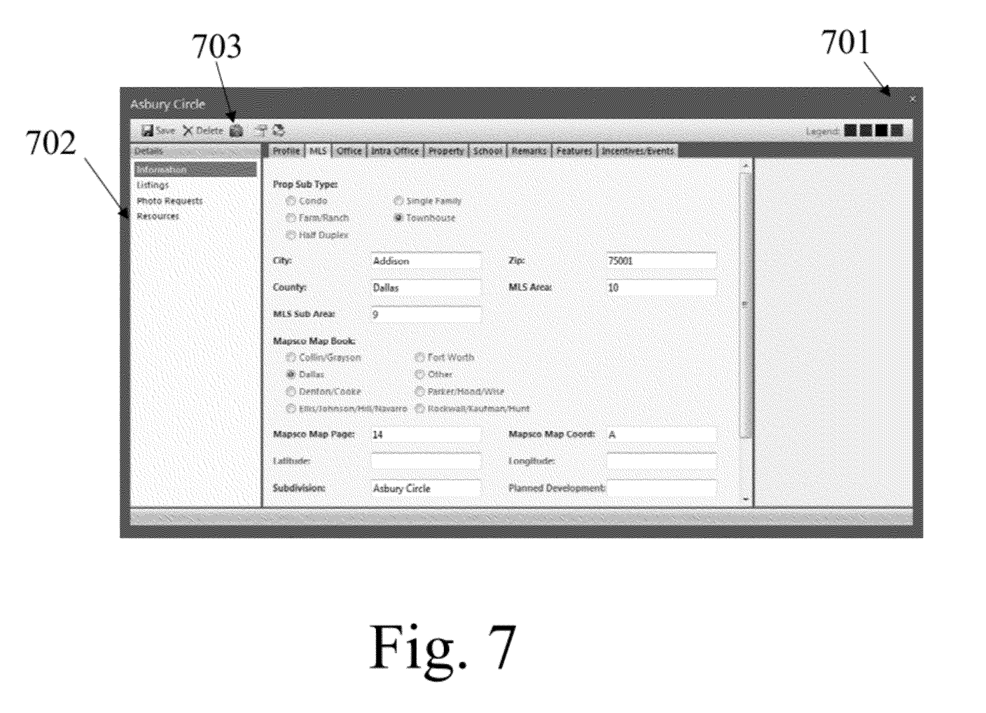

As shown in FIG. 7, photo requests 703 can be submitted and resources 702 can be added to the community profile. A user can select “x” 701 to return to the management page 2400.

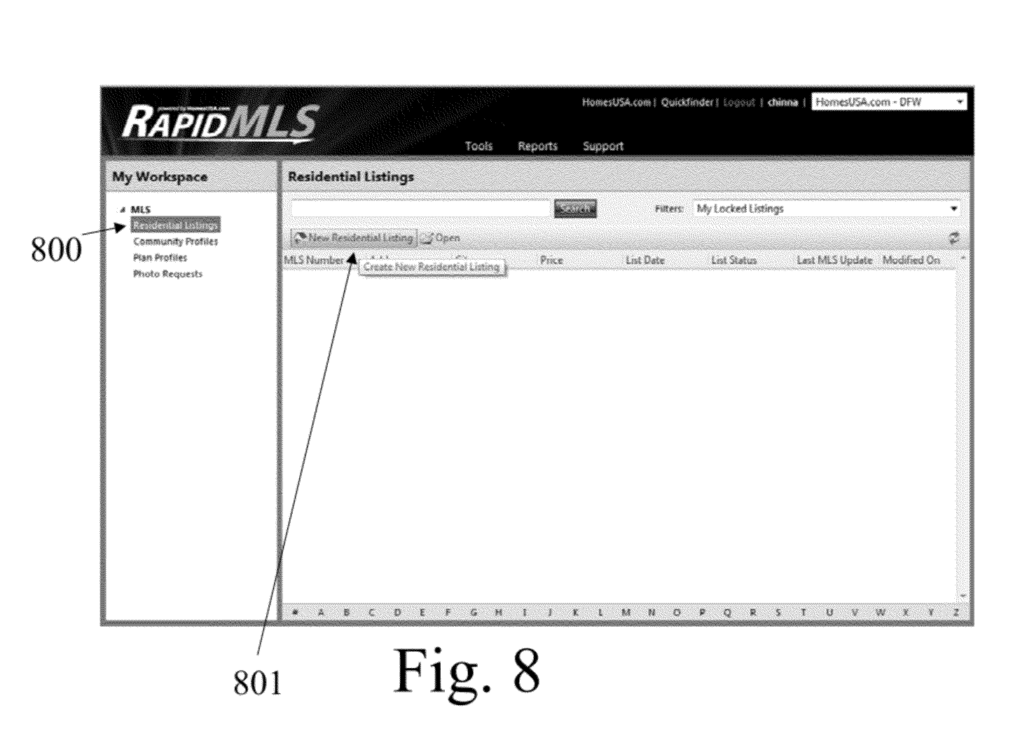

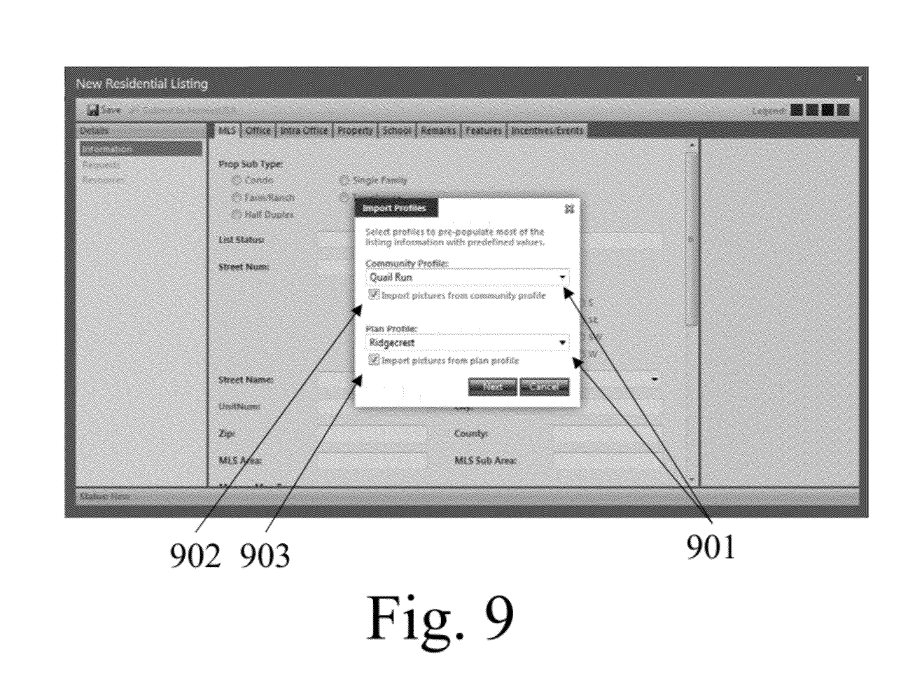

Now referring to FIG. 8 the method for entering MLS information is taught. The system defaults to “Residential Listings” 800 once a user is logged in. A user can select “New Residential Listing” 801. Now referring to FIG. 9, a user can select the drop down arrows 901, select desired Community and Plan Profile from the available options. Pictures from profiles can be imported by entering a check mark in the box below each profile 902 and 903, but is not required. Importing data from profiles lessens time when working with a listing because of pre-populated information.

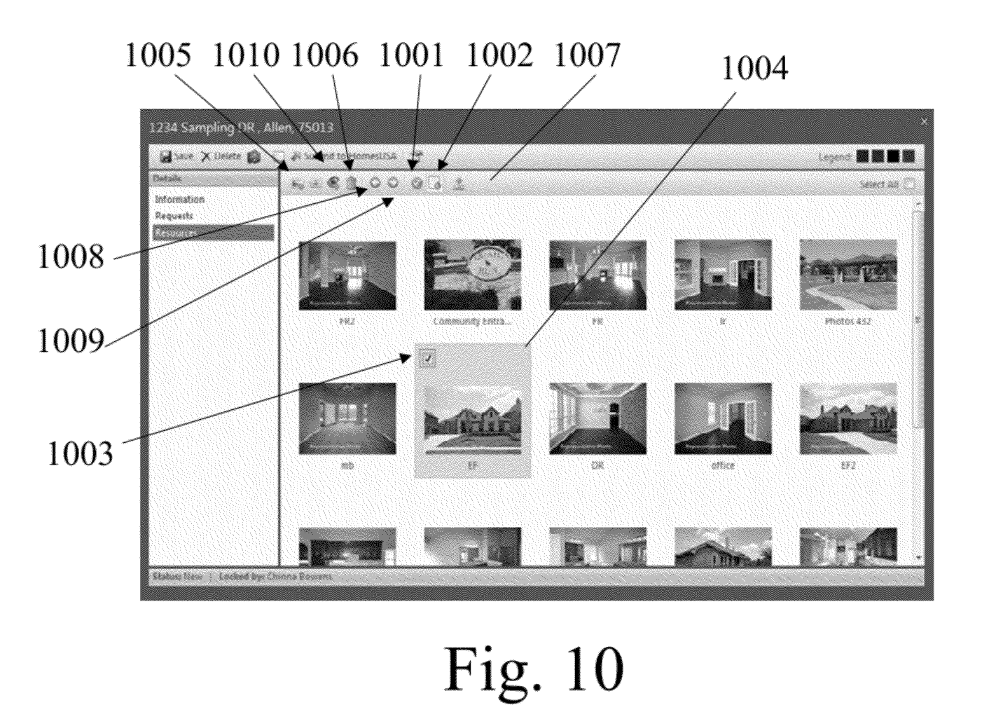

Now referring to FIG. 10, A user can enter a check mark 1001 in the box beside “Select All” 1002 or enter a check mark 1003 in the box beside each photo 1004 and select “Import Selected” or Select “Finish without Resources” to continue to the form. Images can still be imported at a later time.

Next a user will complete the “Property Description” field to describe the home without repeating information that is in other areas of the listing, such as “Beautiful 1 story, 4 bedrooms, 2.5 baths, 2 car garage, etc. This information will be included in other fields. If Incentives or Realtor Bonuses are being offered, it may be publicized by entering here. This segment is optional, if nothing is being offered, nothing is required. When entering information on this segment it is added to the “Private Remarks” field after the standard wording. Incentives/Events are not to be entered or modified in the “Private Remarks” field, use the “Incentives/Events” segment only for this purpose. Open Houses are not to be entered or modified in this segment of this object. They are to be entered or modified in the “Community Profile”. Any upcoming community events aside from Open Houses can also be entered in this segment of the “Community Profile” or in this object. The “Notification” box shown above will be displayed to indicate a “Saved” request was successful, but not submitted. Select “OK”.

Knowing the Resources Manager Toolbar Upload files such as jpg, jpeg, pdf, txt. A user can: Import pictures from community and plan profiles; Add a virtual tour; Delete resources; Change the order of resources (only one resource must be selected for this function to work); Set primary picture (only a picture can become the primary and only one must be selected for this function to work; and Use watermark as representative pictures; and download resources in a zip file on computer to be used for personal use, such as brochures, flyers.

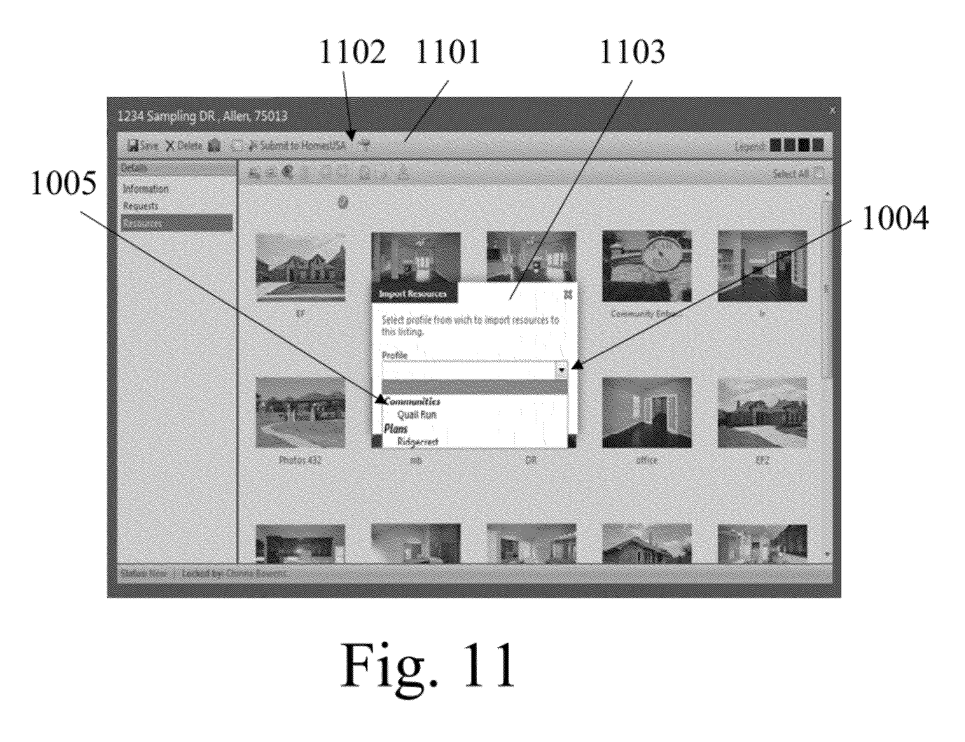

Now referring to FIG. 10, to select a primary picture, enter a check mark 1001 in the box beside the photo. Select the check mark in the toolbar 1002. When hovered over the tool, the information of it appears. In one example it may read “Set as primary picture”. After selecting the check mark 1001, the picture selected moves to the beginning and is indicated with a check mark that it is the primary picture. Pictures are automatically watermarked as “Representative Photos” when imported from plan profiles. To identify whether pictures are set as representative the tool is lit up in yellow or highlighted in some equivalent manner. If they are not set as representative the icon, it is lit up as black or highlighted in some equivalent manner. To remove the watermark, enter a check mark in the box beside each photo that is not a community photo. Select on the tool that looks like a picture frame 1005. To delete photos, enter a check mark in the box beside the photo(s) to be deleted. Select on the trashcan 1006 in the toolbar 1007. After selecting on the trashcan 1006, a notification pops up asking “Are you sure you want to continue”, select “Yes”. Photos can be moved forward and back. To do so, enter a check mark in the box beside the photo. Select on the arrow moving forward 1008 or backward 1009. To upload pictures from a computer select on the tool with a plus sign 1010. When hovered over the information for that tool appears. A window similar to the one shown in FIGS. 11-13 pops up after selecting “Upload Files”. A user would then browse the computer for the pictures to be uploaded. To select them all at once by selecting on the first picture and then while holding down the “Ctrl” button on or the “Shift” button on the keyboard, select all the picture to be uploaded. Select “Open”. After selecting “Open” a user would notice in the background the pictures uploading and the status.

Now referring to FIG. 11, to import resources from community or plan profiles, select on the second tool 1101 in the toolbar 1102. A box 1103 pops up to select resources from a profile. Select on the down arrow 1104 and select the profile 1105 to import from. Select “Import” and enter a check mark beside the picture(s) to be imported.

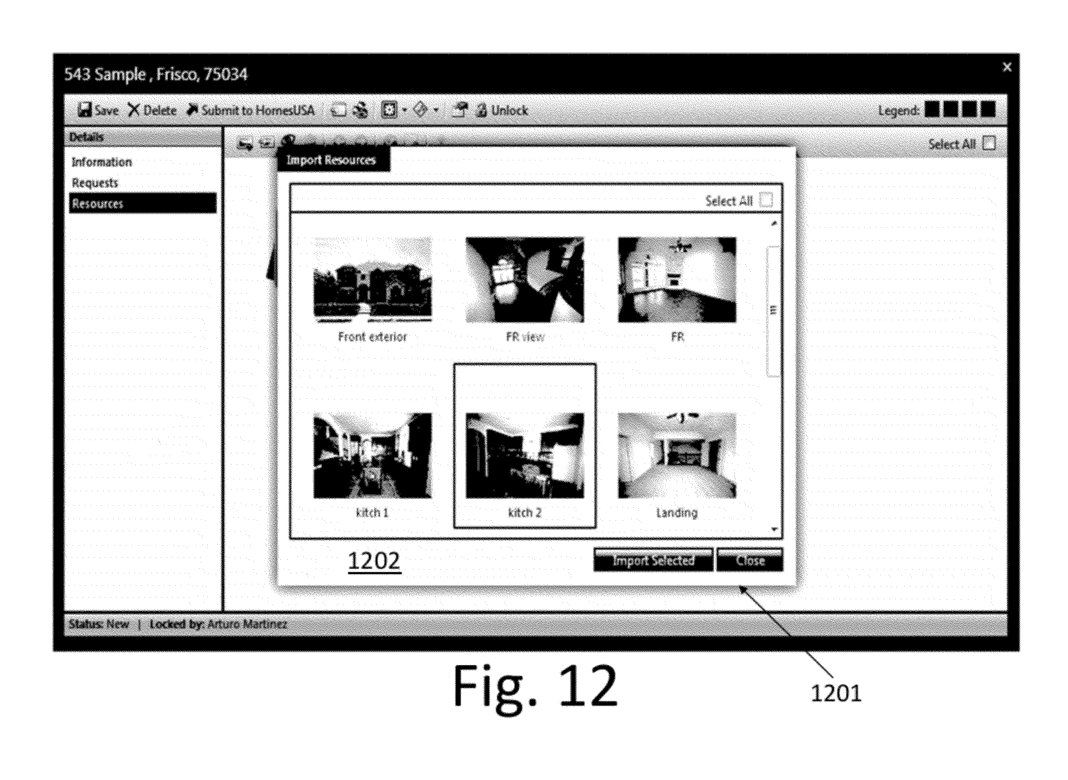

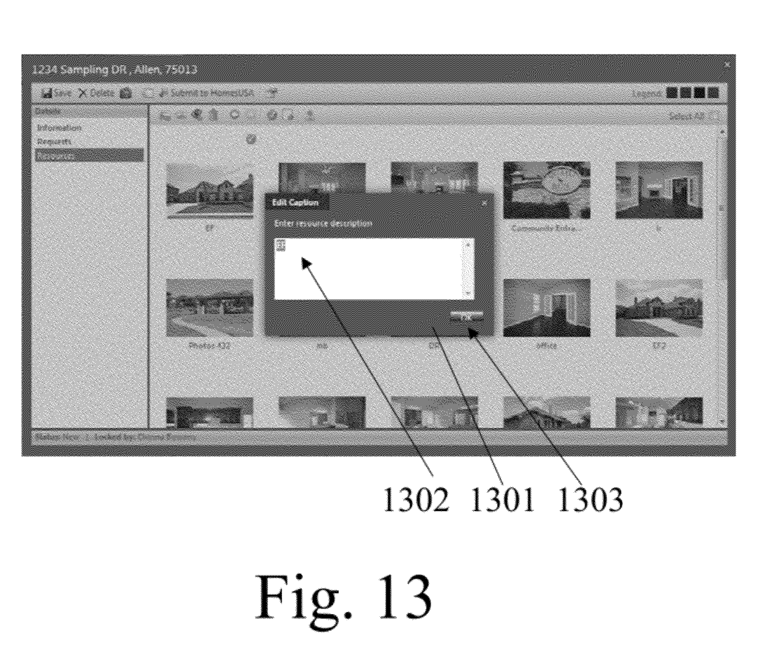

As shown in FIG. 12, select “Import Selected” 1201. Descriptions of pictures can be edited by double selecting on the text below the picture 1202. After doing so a box 1301 appears as shown in FIG. 13 to edit the text. Type in the new description 1302 and select “OK” 1303, the caption will show the new text entered.

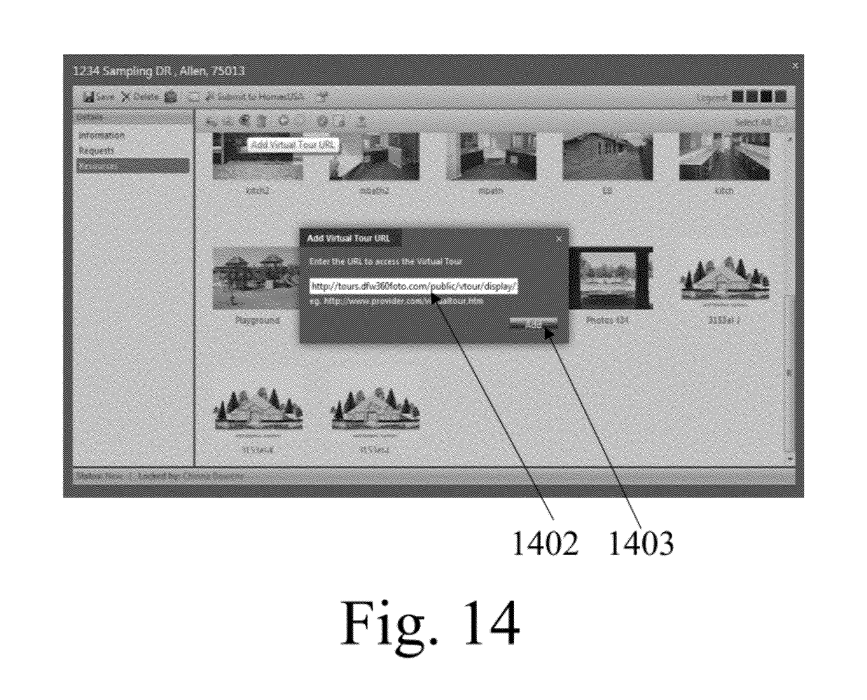

Virtual tours can be added by selecting on the eye with a plus sign 1401 as shown in FIG. 14. Enter the hyperlink of the tour 1402 and select “Add” 1403. After successful upload the virtual tour added is posted with all other media.

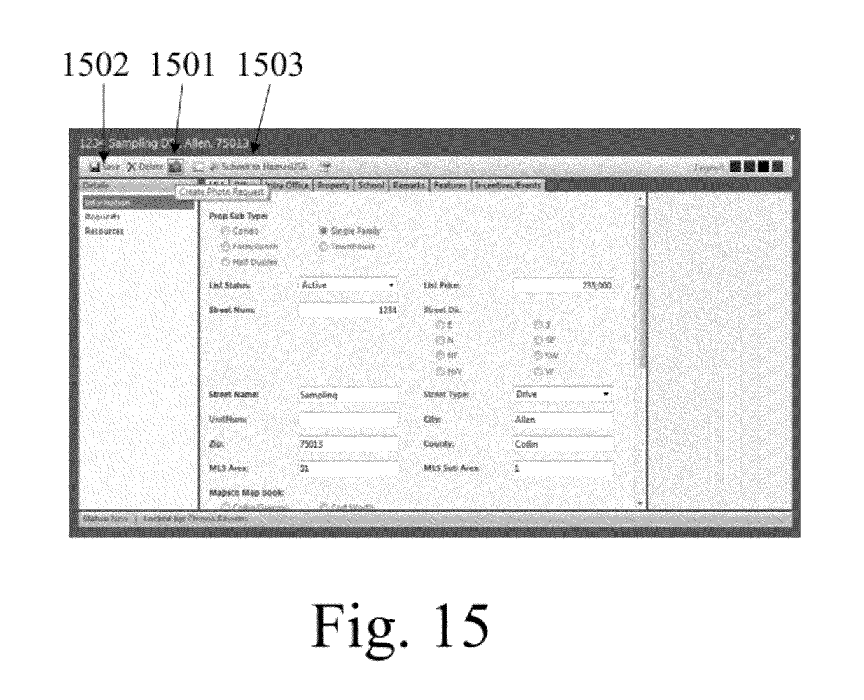

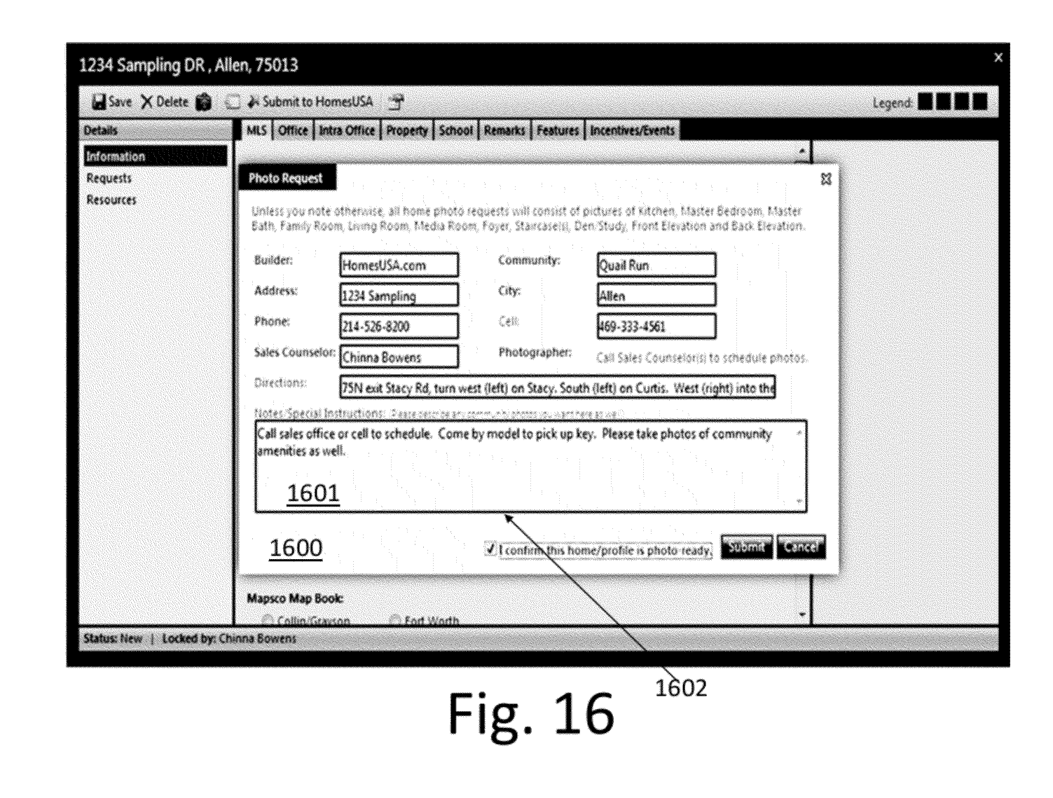

Now referring to FIG. 15, to initiate a photo request a camera icon 1501 appears after a successful request is saved after selecting “Save” 1502 and/or “Submit to HomesUSA” 1503. Select the camera icon 1501 to display the “Photo Request” form 1600 as shown in FIG. 16. Builders subscribing to a full service may request photos of completed homes for no additional charge. The “Photo Request” form 1600 as shown in FIG. 16, will appear as shown above. Most of the information on the form 1600 has been pre-populated. A user must check all information for accuracy including cell number. If information is missing, a user will enter it so the photographer may contact them for access. A user may also enter any notes or special instructions for the photographer in the “Notes/Special Instructions” section 1601. A user then confirms the home is photo ready by entering a check mark in the box 1602. After successful submission, a notification appears.

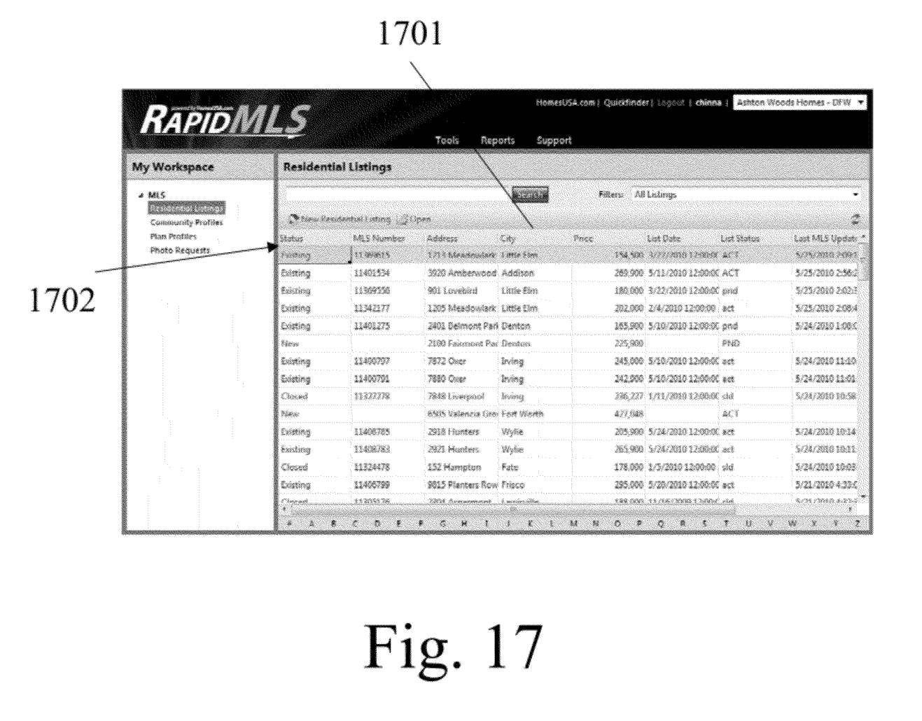

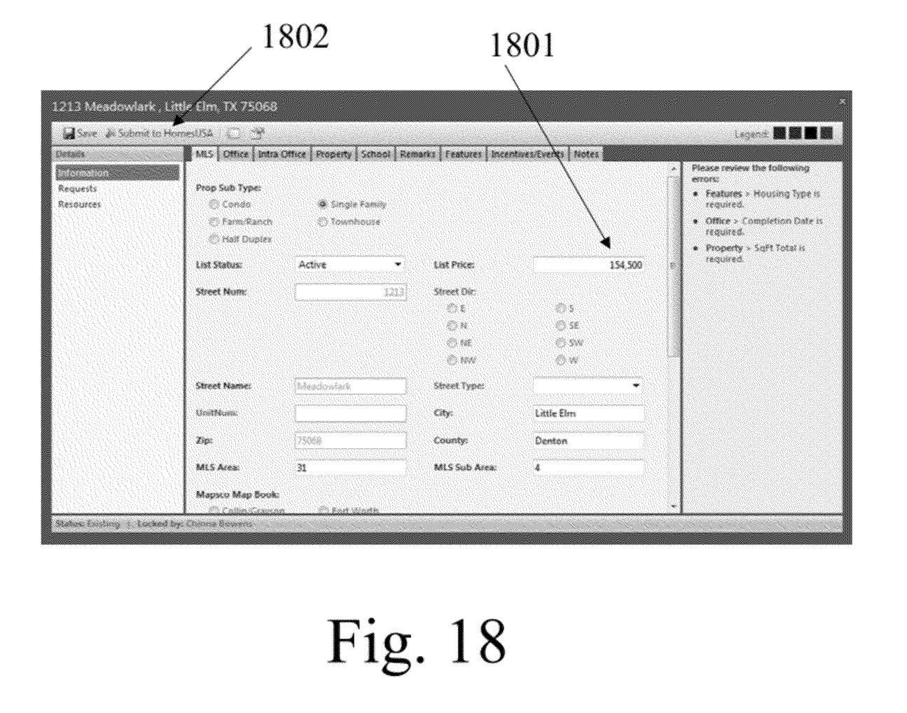

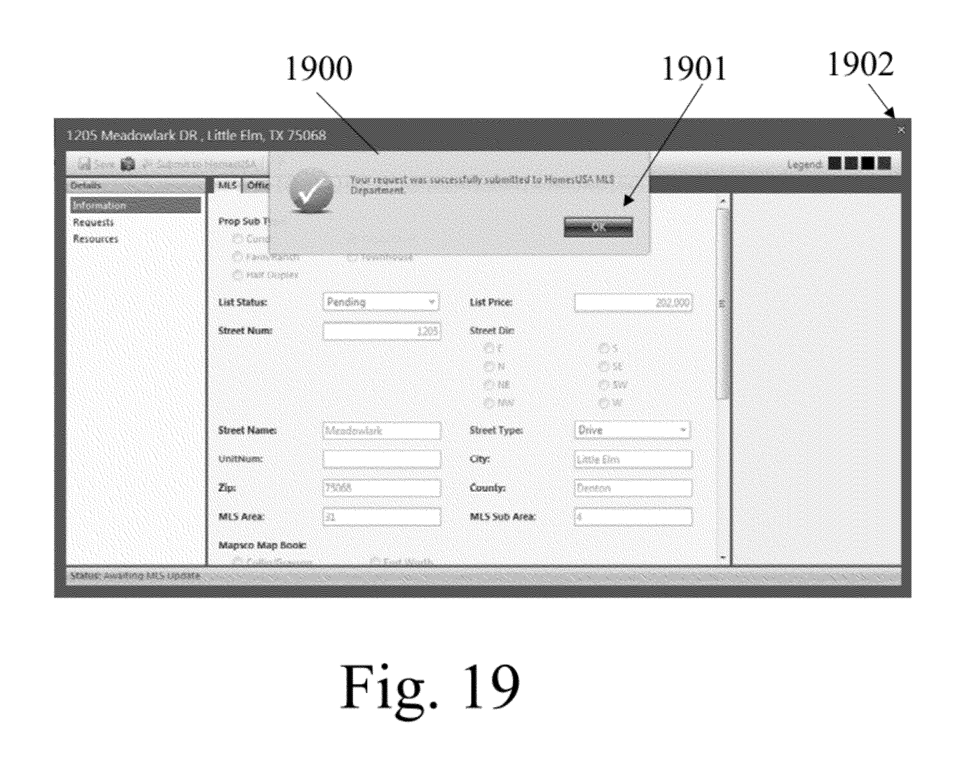

To update an MLS listing a user must first open a listing by placing the cursor over the subject property 1701, it will be highlighted 1702, then select twice, or select on the listing once then select “Open” as shown in FIG. 17. As shown in FIG. 18, a user may update a list price 1701, or other information by highlighting the item to be changed and entering the new information. Price does not require dollar sign ($); comma (,) or decimal (.). After updating desired items, as user selects “Submit” 1702. If errors exist, the user then corrects any errors displayed and re-submits. The notification box 1900 shown in FIG. 19 will be displayed after the system has accepted the update. A user then selects “OK” 1901 to close the notification box 1900. A user may also select “x” 1902 to return to the Management page 2400.

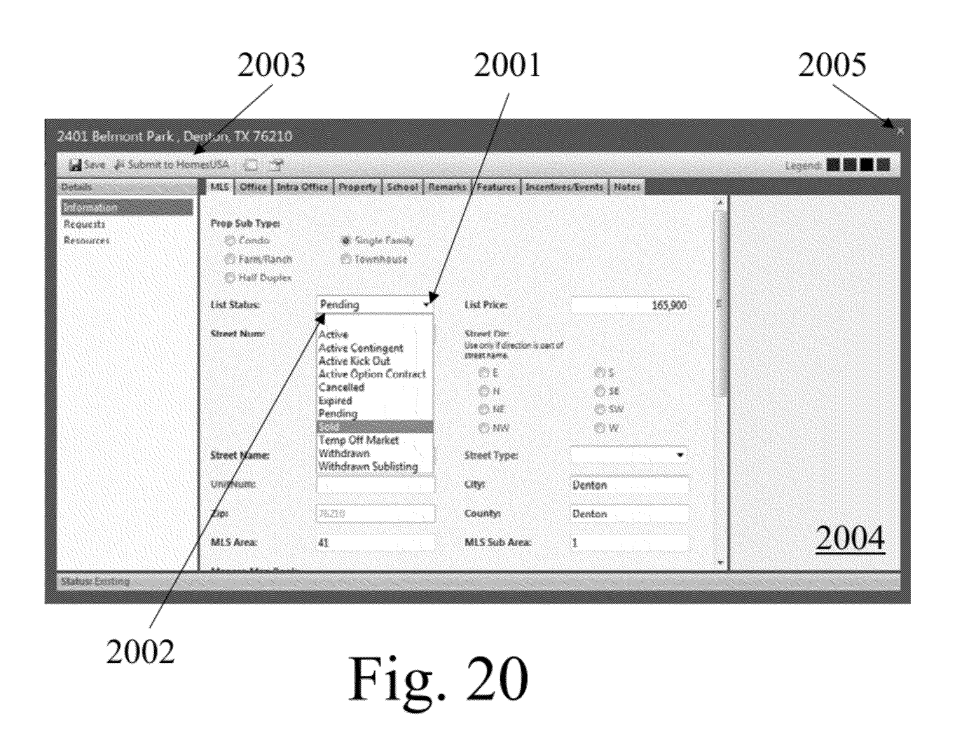

To update a status, a user must access the update section then select “List Status” 2001 for the drop down menu and select status 2002 to be changed. After selecting status 2002, as shown in FIG. 20, change select “Submit to HomesUSA” 2003. If errors are indicated in the panel to the right of the screen 2004 a user must make the necessary corrections on the segments indicated and re-submit. A user then selects “OK” to close the notification box and the user may also select “x” 2005 to return to the Management page 2400.

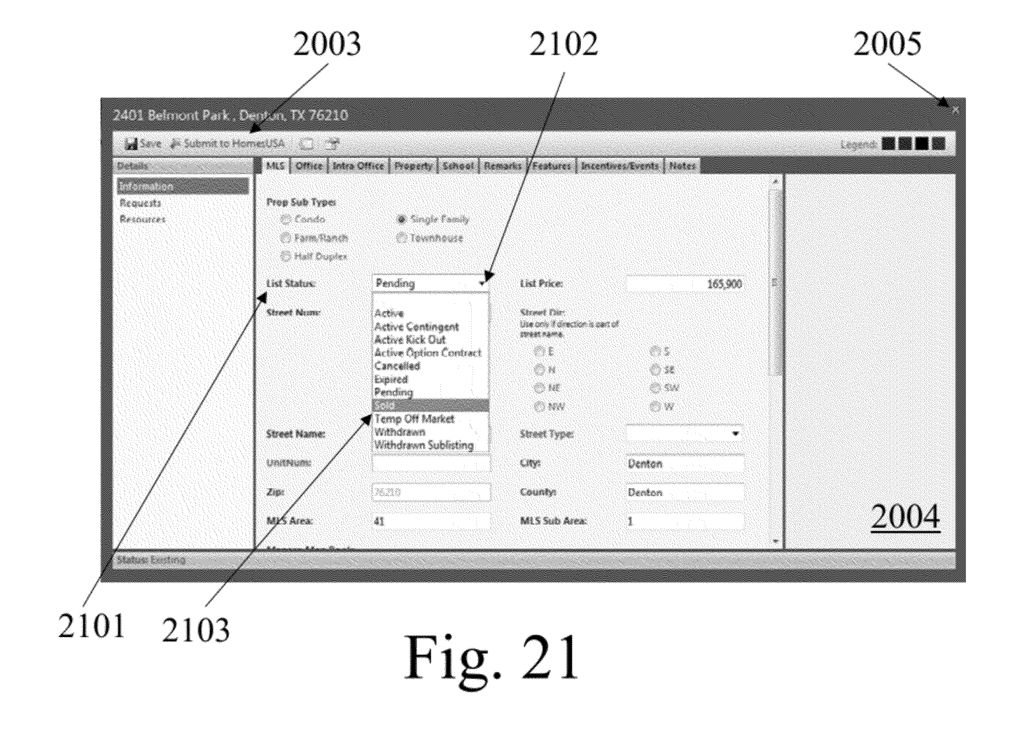

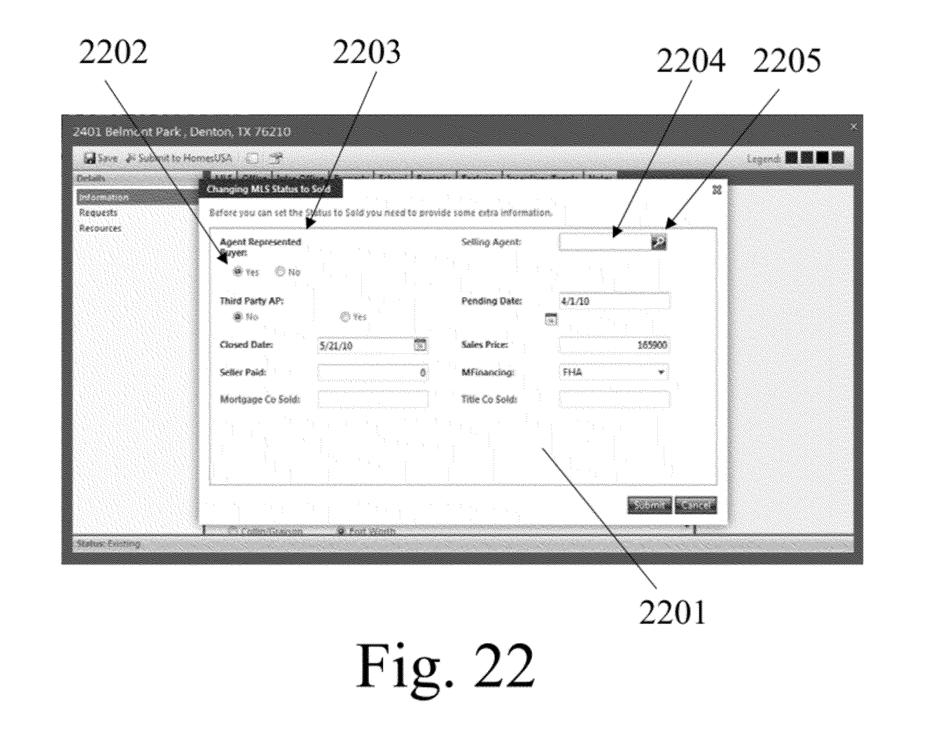

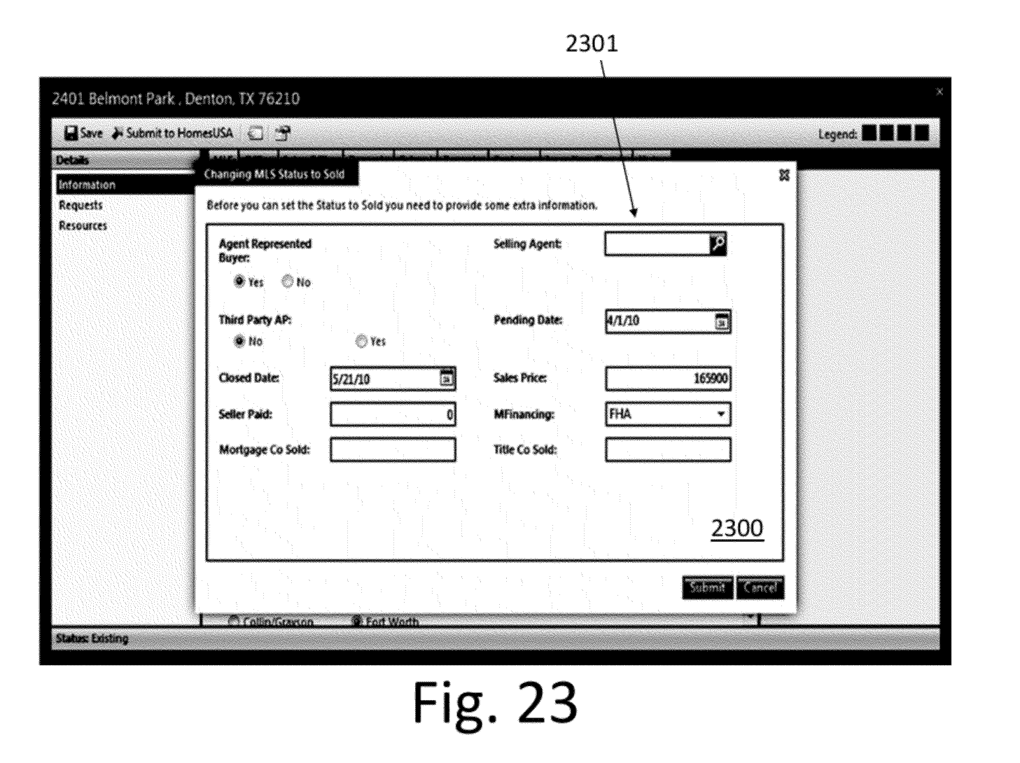

To update a status, a user must access the update section then select “List Status” 2101 from the drop down menu 2102 and select status to be changed as shown in FIG. 21. Before changing list status to “Sold” 2103, additional information is needed. A user must fill in required fields 2201 as shown in FIG. 22. If “Yes” 2202 was selected for “Agent Represented Buyer” 2203 then “Selling Agent” 2204 is required, a user can select on the magnifying glass 2205 to search for the agent and follow the next steps to enter the Selling Agent's information in the appropriate fields. It is not necessary to complete all field, entering less information yields more names. Entering more information yields fewer names. If the agent name is still not found, a user should select “No” 2206 for “Agent Represented Buyer” 2203 and email agent information to include in MLS. A user may select “Search” to select the Selling Agent by selecting on the agent's license number. Selecting the agent's license number populates their information in the form 2300 as displayed in FIG. 23.

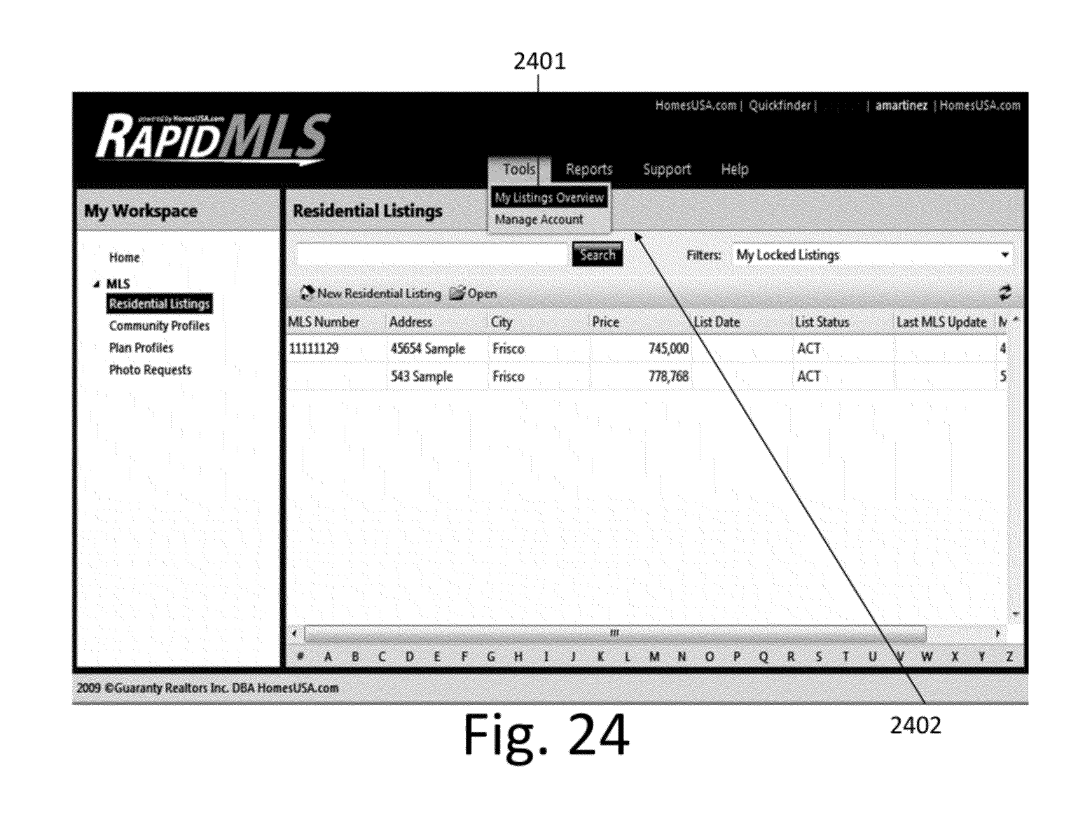

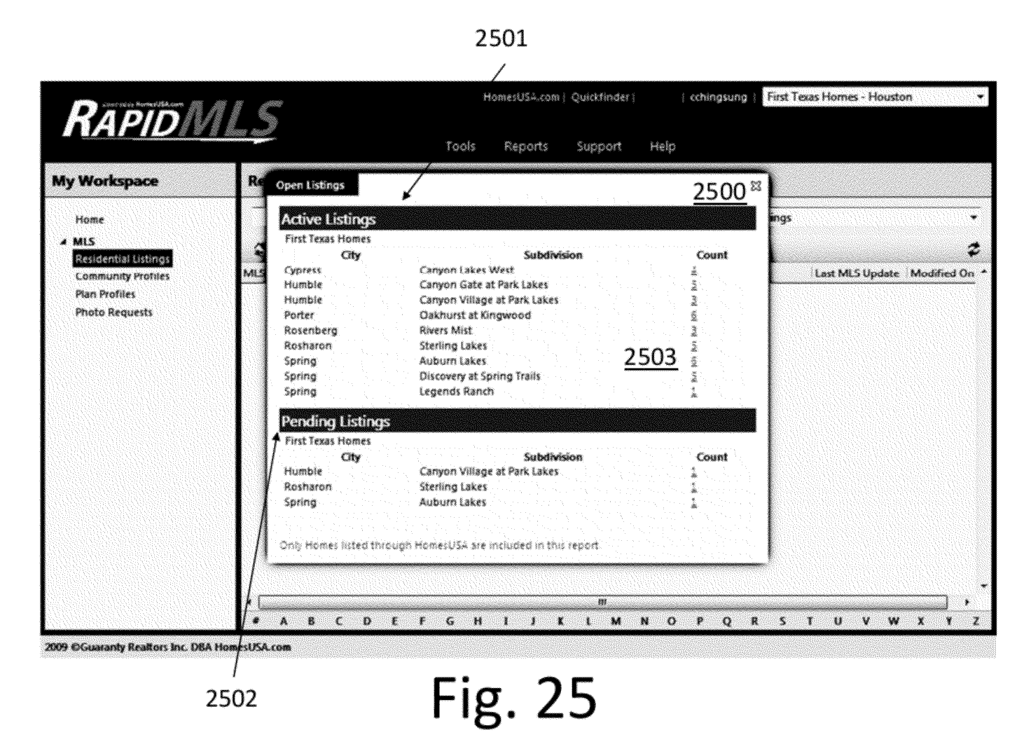

Now referring to FIG. 24, an overview of the system and method for Rapid MLS Listing Management is displayed. A user can place a cursor over “Tools” 2401. Select “My Listings Overview” 2402 to display the page 2500 shown in FIG. 25. “Active” listings 2501 will appear at the top followed by “Pending” listings 2502, and other listing statuses (if any) will follow. To view “Pending” listings 2502 a user would select the number in the “Count” column 2503 to see thumbnails of listings for a specific community.

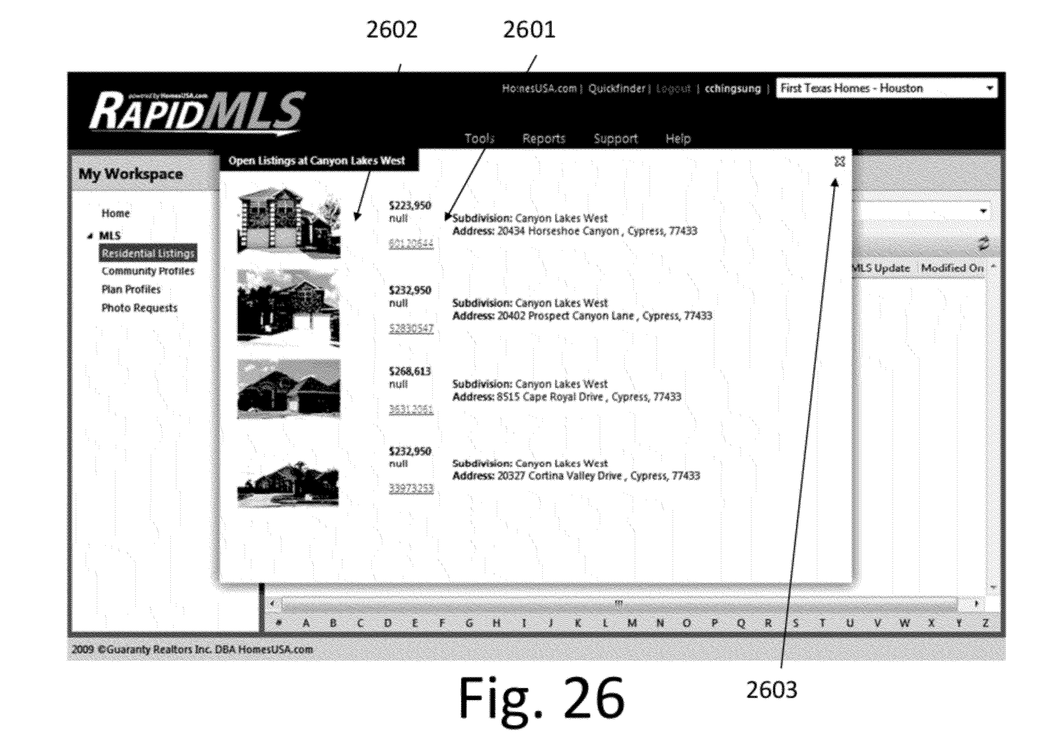

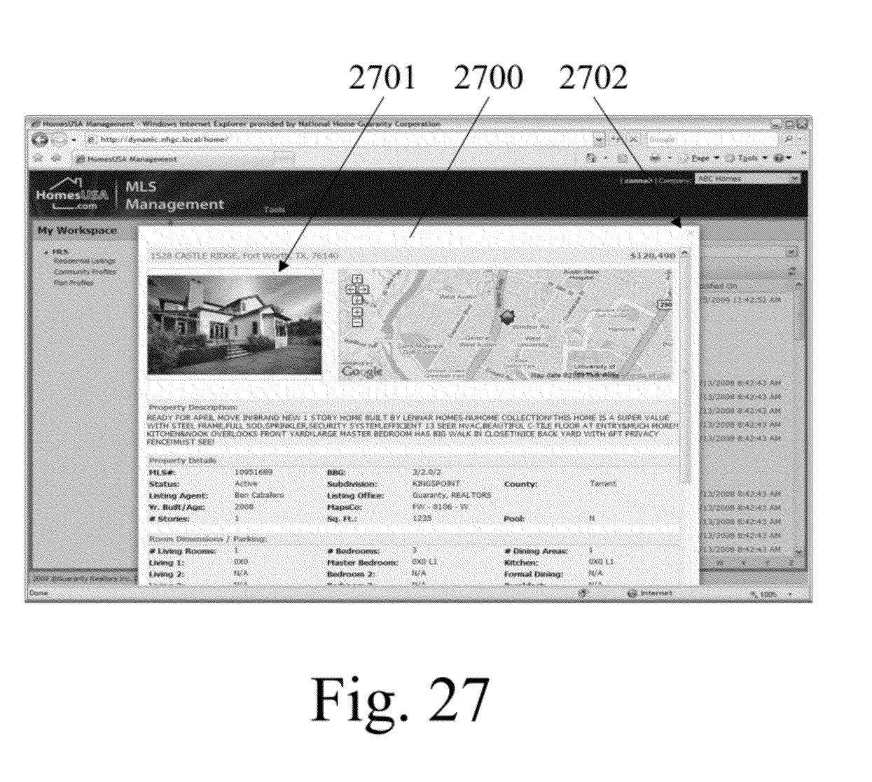

Now referring to FIG. 26, a user would select the MLS number 2601 or photo 2602 to view the full listing details as shown in FIG. 27. Select “x” to return to the MLS Management page. The user may also select “x” 2603 to return to the Management page 2400.

Now referring to FIG. 27, a user may select a photo 2701 to view other images. A user may also select “x” 2701 to return to the MLS Management page 2400.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A program storage medium readable by a machine, tangibly embodying a program of instructions executable by a machine to perform the method steps comprising:
creating one or more profiles;
creating an MLS listing;
using the profiles to populate MLS data into the MLS listing form with profile information;
reviewing and entering listing specific information that is not found in the profiles but is desired to be part of the MLS listing information;
sending the MLS listing to an administrator for approval;
locking the MLS listing to prevent editing pending administrator approval;
reviewing the MLS listing request for accuracy by the administrator;
approving or rejecting the MLS listing request;
generating a read only MLS listing request;
sending an approved read only MLS listing request to an MLS listing service, where it is received and stored the approved MLS listing request by an MLS server; and
receiving and storing the approved MLS listing request by a system server and database for review, monitoring, and editing.

2. The method of claim 1, wherein the profile is a creating community/subdivision profile.

3. The method of claim 1, wherein the profile is a plan profile.

4. The method of claim 2, wherein the community/subdivision profiles include: city, subdivision name, directions to subdivision, office phone number, Zip code, school district, school names, map coordinated et cetera never change.

5. The method of claim 3, wherein the plan profiles include stories, bedrooms, baths, type construction, roof type, type parking et cetera remain constant.

6. The method of claim 1, further comprising the steps of:
unlocking the MLS Listing for editing if it is rejected;
notifying a submitting user by email of the rejection and errors in the MLS Listing request;
providing the submitting user the opportunity to correct and resubmit the MLS Listing request;
reviewing the MLS listing request for accuracy by the administrator up resubmission; and
approving or rejecting the MLS listing request.

7. The method of claim 1, further comprising the steps of:
storing the program storage medium readable by a machine, tangibly embodying a program of instructions executable by a machine to perform the method steps on a system server;
providing an MLS application module;
providing a web service API;
enabling user access to the MLS application module 2 stored on the system server via a webs service API;
providing authentication and access authorization by the system server and web service API;
granting access to the MLS application module; and
importing data from community/subdivision profiles and plan profiles into the MLS listing.

8. The method of claim 1, further comprising the steps of:
generating a read only MLS listing;
subjecting the read only MLS listing to a realtor review;
approving the read only MLS listing; and
submitting the read only MLS listing to an MLS listing service, where it is received and stored the approved MLS listing request by an MLS server.

9. The method of claim 8, further comprising the steps of:
unlocking the read only MLS listing for editing if it is rejected;
notifying a submitting user by email of the rejection and errors in the MLS Listing request;
providing the submitting user the opportunity to correct and resubmit the MLS Listing request;
reviewing the MLS listing request for accuracy by the administrator up resubmission; and
approving or rejecting the MLS listing request.

10. The method of claim 1, further comprising the step of: reviewing the MLS listing by a MLS listing service to ensure it complies with the MLS listing service's protocol.

11. The method of claim 1, further comprising the step of: distributing the MLS listing to external MLS system and a syndication of websites.

12. The method of claim 2, further comprising the step of:
selecting a listing;
importing information from a listing; and
entering a name of a community being created.

13. The method of claim 12, further comprising the step of:
submitting photo requests;
adding resources to a community profile; and
importing photos.

14. The method of claim 1, further comprising the step of:
adding virtual tours; and
entering the hyperlink of the virtual tour.
